(19) United States
(12) Patent Application Publication
(10) Pub. No.: US 2011/0001313 A1
(43) Pub. Date: Jan. 6, 2011

(54) Server Organizer

(76) Inventors: Dwight Gwin, Katy, TX (US); Ryan Kluge, Humbla, TX (US)

Correspondence Address: Jason Celaya, Esq., 20606 Prince Creek Dr., Katy, TX, 77450, US

(21) Appl. No.: 12/497,646

(22) Filed: Jul. 3, 2009

(51) Int. Cl. B42D 3/12

(52) U.S. Cl. 281/30; 281/31

(57) ABSTRACT

A server organizer for retaining tools and items for use in staff support services, including writing utensils, writing tablets, currency, coins, order slips, lighters, bottle openers, wine keys, other tools related to support services, and combinations thereof A server organizer includes a cover having exterior surfaces and interior surfaces, in which the interior surfaces comprise a plurality of pockets, pouches, inserts, and storage compartments for accommodating items and tools related to food service and the restaurant industry.

### RELATED APPLICATION

This application claims the benefit of U.S. provisional application No. 60/______ filed Jul. 3, 2008 and entitled “Server Organizer” which is hereby incorporated by reference herein, and claims the benefit thereof.

### TECHNICAL FIELD

The present disclosure relates generally to a portable organizer and more particularly, to an organizer for retaining tools for use in staff support services, including, but not limited to writing utensils, writing tablets, currency, other tools, and combinations thereof.

### BRIEF BACKGROUND

In the restaurant service industry, it is common to manage multiple service tickets, various amounts of change, or other required tools to support the customer's needs and to operate effectively. There are various products, in existence today, that resemble a billfold, wallet, and the like. These products are limited in size, storage space, and by the weight of the item to be supported therein. The typical restaurant server generally has to hold items in multiple places such as in various pockets or multiple articles of clothing, which is ineffective and inefficient. Alternatively, servers store their occupational tools at their place of employment and must take time to retrieve, use, and restore the items, each time the server needs to use the items.

### BRIEF DESCRIPTION OF DRAWINGS

For a further understanding of the nature and objects of the instant disclosure, reference should be had to the following detailed description, taken in conjunction with the accompanying drawings, in which like elements are given the same or analogous reference numbers.

FIG. 1 illustrates a perspective view of an embodiment of a protective cover for a server organizer in accordance with the present disclosure;

FIG. 2 illustrates a front perspective view of an embodiment of a protective cover for a server organizer in accordance with the present disclosure;

FIG. 3 illustrates an inside perspective view of one side of an embodiment of a server organizer in accordance with the present disclosure;

FIG. 4 illustrates an inside perspective view of another side of an embodiment of a server organizer in accordance with the present disclosure;

FIG. 5 illustrates a perspective view of a back cover of an embodiment of a server organizer in accordance with the present disclosure; and

FIG. 6 illustrates a perspective view of an embodiment with a removable protective cover for a server organizer in accordance with the present disclosure.

### DETAILED DESCRIPTION OF EMBODIMENTS

The embodiments of the organizer disclosed herein allow for users to be more organized, prepared, and professional. Most of the essential tools that a server, other wait staff, valet, or the like needs to keep organized through their shift can be easily placed inside the organizer disclosed herein. The organizer is preferably utilized for holding, organizing, and maintaining the tools necessary to perform the job function required by a server or waiter either in the food service industry or similar industry. It should be understood that the term waiter or server is meant to be generic herein and includes other terms that refer to wait staff, assistants, valets, clerks, and the like. It should be further understood that the term tool refers to tools of the trade for the particular user of the apparatus described herein. Thus, as the preferred embodiment is described herein in terms of the food service industry, the tools may be items such as, but not limited to, pencils, pens, calculators, bottle openers, can openers, cork removers, order pads, note pads, lighters, money, cards, change, PDA' s and similar articles carried by waiters. Preferably, the organizer can be carried and/or concealed on the person of the user. In one embodiment, the server organizer can include a hard cover bifold book design for retaining a ridged form and protection of the contents housed within the organizer. Alternatively, the cover can be made of a softer material, such as pliable leather or plastic that can protect the contents. In another embodiment, the cover is a one-piece cover that is folded to form a protective covering for retaining the stored items. Alternatively, the cover can be a two-piece cover that is connected to form a protective covering for storing the items therein.

In one embodiment, the organizer can include numerous pockets, pouches, inserts, and other storage compartments, which can be made of a transparent and/or translucent material, for storing items as well as allowing the server or waiter to see the items being stored. It should be appreciated that an opaque material can also be utilized when seeing the items contained therein is not necessary. Preferably, the dimensions of the storage compartments, pockets, pouches, and inserts can be designed to hold such tools as a writing utensil, paper or notepad, monetary instruments, a food ordering ticket, a check, a lighter, a bottle opener, a wine opener, other commonly used tools of the trade, and combinations thereof.

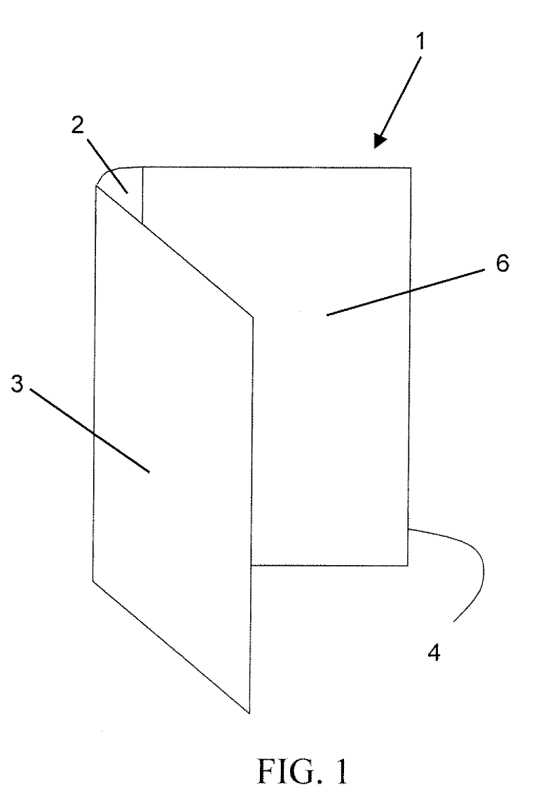

Referring now to FIG. 1, there is depicted an embodiment of a protective cover for a server organizer 1. In this embodiment, the protective cover may be a one-piece cover that is folded to form a protective covering for retaining the stored items. The one-piece protective cover can open in a book like fashion, by employing a flexible binding 2 along a side of the covers 3, 4 to form a spine. In an alternative embodiment, the protective cover can be a two-piece cover, in which the two pieces can be connected, for example by use of a hinge, binding, or other connector, to form a continual protective covering for storing the items within the organizer 1. It should be appreciated that the binding 2 can be a variety of conventional connectors that allow the organizer 1 to be opened and closed. However, binding 2 should be of sufficient strength to allow operation of the organizer 1 without spilling the contents therein.

The protective cover 3, 4 each comprise an inside portion to retain and protect any articles or tools placed therein. In one embodiment, the server organizer 1 can include a hard protective cover that can be a bi-fold book design for retaining a ridged form and protection of the contents housed within the organizer 1. It should be understood that the terms back cover and front cover, as well as right side or left side are used for illustration in order to provide a better understanding of the organizer 1 described herein. However, the configurations of the back, front, right, or left can be interchanged and should not be viewed as a limitation herein. FIG. 1 further illustrates an inside 6 portion of cover 4. It should be appreciated that the covers 3, 4 may alternatively be made of a softer material such as a softer leather that can protect the items and/or tools within the organizer 1. It should be further appreciated that the covers 3, 4 may be any combination of soft and/or rigid material. Still further, the covers 3, 4 may be detachable and of various colors to correspond to the requirements of the establishment using such.

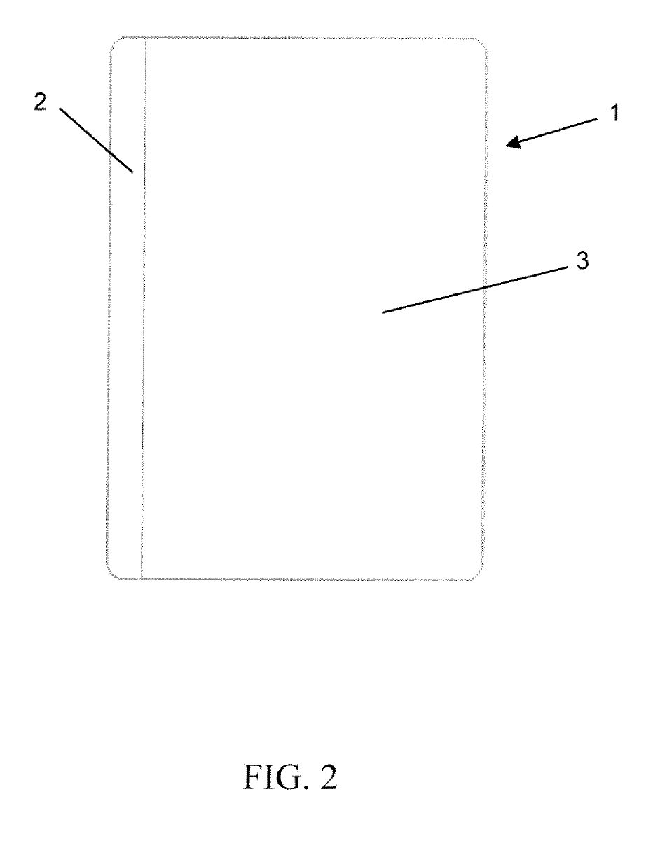

FIG. 2 illustrates a front view of an embodiment of the server organizer 1. The server organizer 1 can be made in a variety of sizes, shapes, and configurations. For example, not intended to be limiting, the height of the organizer 1 can range from five (5) inches to nine (9) inches and the open face length can range from eight (8) inches to twelve (12) inches. However, it should be appreciated that different sizes are contemplated herein and that the dimensional configurations may vary depending on the intended use of the organizer 1 as well as the tools or instruments intended to be carried therein. In one embodiment of the server organizer 1, a preferred width may be five and one half (5.5) inches, with a one half (0.5) inch overlap for the binding 2, and a length of eight (8) inches, thus retaining and protecting the items and tools carried therein. It is further preferred that the dimensions of the organizer 1 be such that permit the user to carry the organizer 1 on their person, by hand, or concealing it within an apron; all without interfering with the user's range of motion.

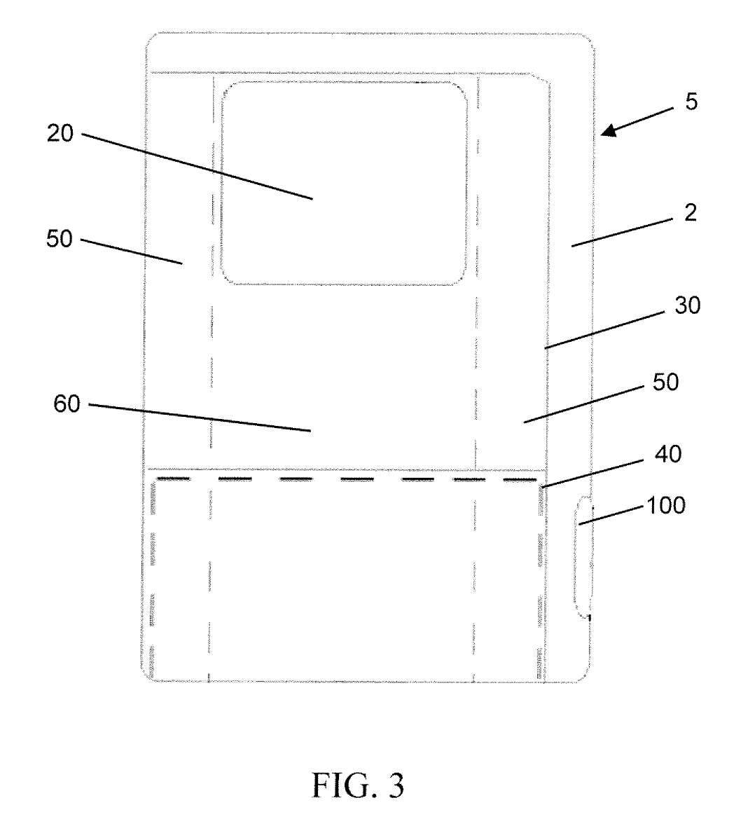

FIG. 3 depicts an inside view of an embodiment of server organizer 1. The inside 5 of the server organizer 1 can include numerous pouches, pockets, inserts, and storage compartments that can be designed to retain the items and/or tools needed by the users of said organizer 1. Preferably, the inside 5 is designed so as to have overall dimensions that are substantially the same as inside 6 thus making cover 3 and cover 4 to have substantially the same overall dimension. However, it has been contemplated herein that cover 3 and inside 5 may be of different overall dimensions as compared to the opposite side cover 4 and inside 6. Such dimensional differences being preferably due to personal or market driven preferences.

In one embodiment, the organizer 1 may include a ticket or bill holder 30. The ticket holder 30 preferably includes an opening located along the top side and the right side adjacent to the binding 2 so that a ticket or bill is less likely to inadvertently exit the server organizer 1 when the server organizer 1 is in a closed position. A pouch 20 may reside on the upper portion of the inside 5 for retaining coins, other miscellaneous items, and combinations thereof. The pouch 20 can be secured or closed by fastener, such as an overlapping flap, a zipper, a Velcro® (Velcro is a registered trademark of Velcro Industries B.V.) fastener, a strap, a seal, a clasp, a snap, other securing device, and combinations thereof. A stitched or otherwise formed and/or attached sleeve 60 may be located in a center portion of the inside 5 of the server organizer 1 and may include an opening. In a preferred embodiment the opening of sleeve 60 may range in size from two and one quarter (2.25) inches to four and one quarter (4.25) inches for retaining paper currency, other similarly sized items, and combinations thereof. It should be understood that the exact size of the opening of sleeve 60 is not intended to be limiting to the disclosure herein.

Still referring to FIG. 3, the organizer 1 may include a stitched or otherwise formed and/or attached pocket 40 that can he located along the lower portion of the inside 5. In a preferred embodiment, pocket 40 may range in width from four (4) inches to five (5) inches and range in length from one and a half (1.5) inches to three and one half (3.5) inches with an opening along the top of pocket 40 that can be used for receiving a calculator, other similarly sized item, and combinations thereof. It should be appreciated that the various described pouches and sleeves must be sized so as to accommodate each other within organizer 1. It should be further appreciated that not all the herein described pouches and sleeves are included in a particular embodiment as well as that additional pouches and sleeves may be included in other embodiments.

A writing utensil holder 50 may be located along the outer sides of inside 5. Preferably the location of holder 50 is along the right and/or left adjoining sides of sleeve 60. Holder 50 is preferably for holding writing utensils such as, but not limited to, pens, pencils, markers, and other writing utensils, as well as other similarly sized items. Preferably, strap 100, which may be used for carrying a lighter, other similarly sized items, and combinations thereof, is attached near the bottom of inside 5. It should be appreciated that strap 100 may be an elastic strap, a Velcro strap, a snap strap, and the like.

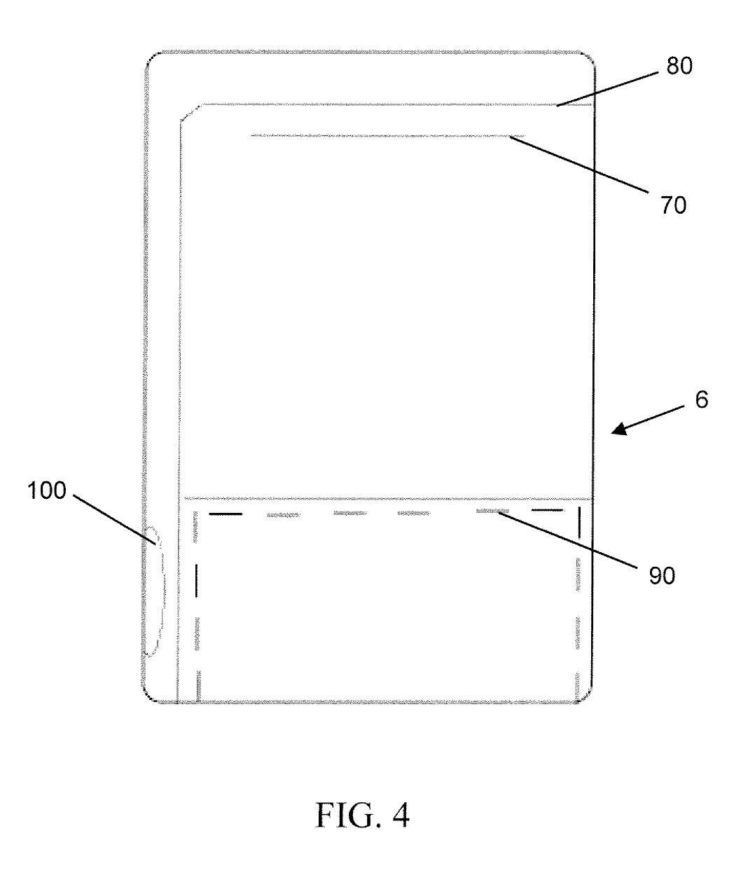

Illustrated in FIG. 4 is inside 6 of an embodiment of server organizer 1. In this embodiment, inside 6 is on the opposite side of the protective cover 4. Preferably, the inside 6 of the server organizer 1 can include numerous pouches, pockets, inserts, storage compartments, and the like to retain various items. Preferably, inside 6 may include overall dimensions that are in relative proportion to the opposite cover 4 and inside 5. In one embodiment, the organizer 1 can include a ticket holder 80. Preferably, ticket holder 80 is similar to holder 30 (see FIG. 3) but on the opposite inside section of holder 30. Further, holder 30 and holder 80 are preferably placed in a minor image fashion with respect to each other. Thus, the opening of holder 80 is adjacent to the binding 2 making a ticket, bill, service check, or a similar items less likely to inadvertently exit organizer 1.

In one embodiment, organizer 1 may include a slot 70. Slot 70 preferably includes an opening. In a preferred embodiment, the opening may range from two and one half (2.5) inches to four and one half (4.5) inches. Slot 70 is preferably positioned near the upper central portion of inside 6. Slot 70 can be used to retain a notepad, personal digital assistant, other items or tools having compatible dimensions, and combinations thereof. It should be appreciated that the positioning and sizing of the various pouches, slots or other retainers are designed so as to maximize the storage capability of organizer 1.

Further, inside 6 may have therein a stitched or otherwise formed and/or attached pocket 90. Pocket 90 is preferably similar in size and positioning to pocket 40 (see FIG. 3). Pocket 90 may be made in a variety of dimensions. In one embodiment, pocket 90 may be slightly larger than pocket 40. A preferred size range may be a width range of four (4) inches to six (6) inches and a length range of one and one half (1.5) inches to three and one half (3.5) inches. Pocket 90, preferably, includes an opening on the top of pocket 90 for receiving items such as, but not limited to, a gratuity chart, a business card, a Texas Alcohol Beverage Commission (TABC) card, a state required identification card such as, but not limited to, liquor and alcohol boards, health boards, and the like, other similarly sized items, and combinations thereof. Inside 6 may also include strap 100.

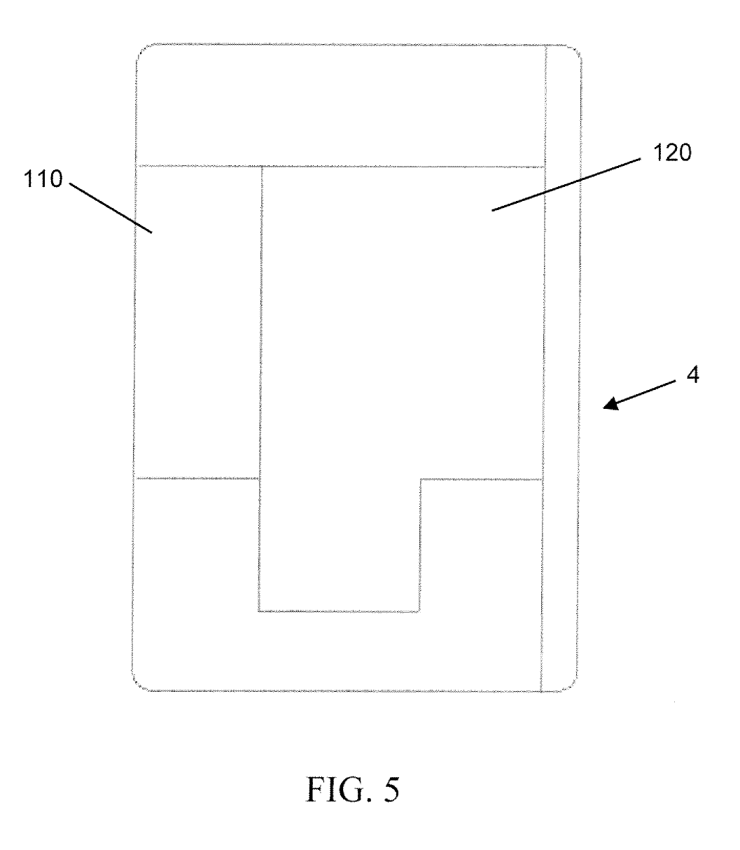

FIG. 5 illustrates further detail of cover 4. As described hereinabove, preferably the dimensions of cover 4 are substantially similar to the dimensions of cover 3, inside 5, and inside 6. However, it should be understood that the dimensions of cover 4, cover 3, inside 5, and inside 6 may vary. As an example not intending to be viewed as limiting, one embodiment of organizer 1 may include cover 4 having a width range of four and one half (4.5) inches to six and one half (6.5) inches, a length range of seven (7) inches to nine (9) inches, and an overlap for the binding in the range of one half (0.5) inch to one and one half (1.5) inches.

Preferably, organizer 1 may include additional pockets for retaining additional items and tools that can be either too large or too bulky to fit in organizer 1 and/or could potentially damage the contents placed in the inside pockets, slots, and pouches when in a closed position. For example and not intended as being limited, additional items such as a wine key or other sharp object for opening beverage containers could potentially damage paper items such as tickets and/or currency. In one embodiment, cover 4 may contain a thick bottle opening sleeve 120. In a preferred embodiment, sleeve 120 may have a width range of one half (0.5) inch to one and one half (1.5) inches, and may have a length range of two and three quarters (2.75) inches to four and three quarters (4.75) inches. It should be understood that sleeve 120 may be designed in varying widths and lengths depending on what type of tools or accessories are intended to be carried therein. Further, sleeve 120 may comprise additional material to receive items comprising larger diameters so as to substantially prevent damage to organizer 1. Cover 4 may further include a thick sleeve 110 that may be positioned adjacent to sleeve 120. Sleeve 110 may be used for carrying additional items such as, but not limited to, writing utensils, a light, a crumber and/or grater, other similarly sized items, and combinations thereof. It should be understood that the contents of the variously described sleeves, pouches, and other containers described herein are primarily for ease of understanding the apparatus described herein and should not be viewed as a limitation herein.

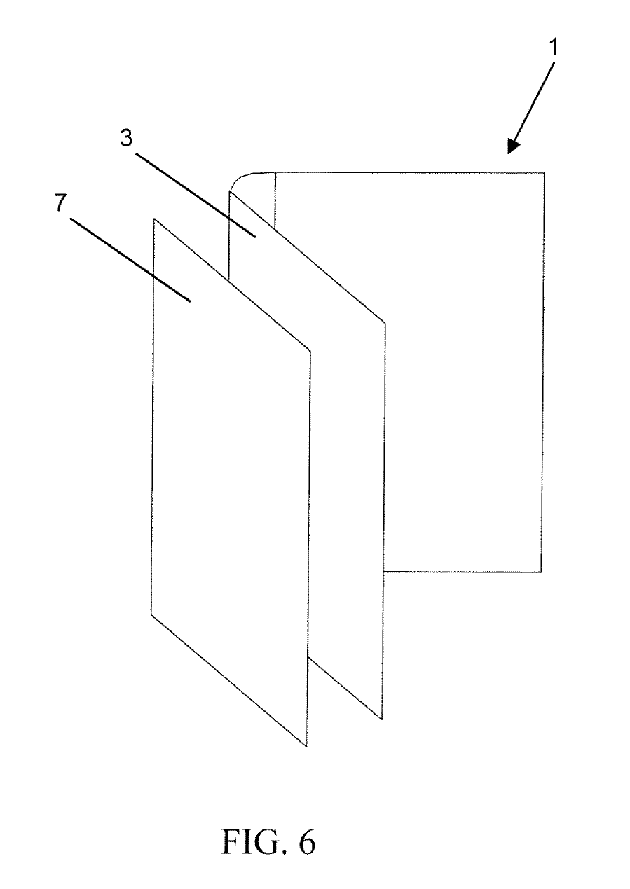

FIG. 6 depicts an embodiment of a removable protective cover 7 for a server organizer 1. In this embodiment, the removable protective cover 7 can be attached to cover 3 and/or cover 4. The removable protective cover 7 can be secured to the cover 3, 4 in a variety of ways such as, but not limited to, an overlapping flap with a Velcro fastener, a strap, a seal, a clasp, a snap, other securing device, and combinations thereof. Preferably, removable protective cover 7 protects organizer 1, thereby extending the life of organizer 1. Further, removable protective cover 7 also allows the user to custom design their organizer 1 by attaching a removable protective cover 7 that is a different color, is embossed by the employer name and/or logo, the name of a particular server or employee, or any other printed design. In addition, the removable protective cover 7 can include additional pockets, pouches, straps, or other spaces to increase the storage capacity of organizer 1.

In operation, the organizer 1 is substantially effective in allowing the user to be efficient, organized, and professional. Preferably at the beginning of the user's shift or prior to a shift, the server may load the organizer 1 with necessary tools and items. The organizer 1 may be assigned to a particular server or may be generally shared by the wait staff. The advantage to assigning an organizer 1 to a specific user is that tools specifically assigned to a particular server may be better tracked thus generating an accountability system for certain employer tools that may be worth above a nominal amount. Such tools may include items such as, but not limited to, PDA's, beepers, telephones, radios, certain state or other government required licenses or identification cards, and the like. When the organizer 1 is assigned to a particular user, the organizer 1 can remain loaded and simply replenished with tools or supplies when necessary.

Preferably, the organizer 1 is sized so as to fit in a pocket or into and/or onto a holder on the server's person. The pocket may also be an oversized pocket in the server's uniform, jacket, apron, or other working outfit. The loaded organizer 1 is then placed in the server's pocket or it may be carried if the server does not require two hands to conduct a particular duty. Once the organizer 1 is loaded and pocketed, the server is ready to serve customers. The server now has easy access to take orders, provide lights to smoking patrons, open wines and other bottled beverages, provide change, keep track of patrons orders and/or credit cards. Further, in the event that the server must show identification to any local, state, or federal officials, the server will have access to state and government agency required licenses or identification cards.

While the present system has been disclosed according to preferred embodiments, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the system or methods disclosed herein to those particular embodiment configurations. These terms may reference the same or different embodiments, and are combinable into aggregate embodiments. The terms “a”, “an” and “the” may also mean “one or more”. Thus, when a single embodiment is described herein, it will be readily apparent that more than one embodiment may be used in place of a single embodiment. Similarly, where more than one embodiment is described herein, it will be readily apparent that a single embodiment may be substituted for that one device. None of the description in this specification should be read as implying that any particular element, step or function is an essential element which must be included in the claim scope. Unless explicitly recited, other aspects of the instant disclosure as described in this specification do not limit the scope of the claims. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense. Obviously, other modifications and variations of the present invention are possible in the light of the above teachings. It is therefore to be understood that changes may be made in the particular embodiments described above which are within the full intended scope of the invention as defined in the appended claims.

What is claimed is:

1. An organizer for holding various wait staff tools comprising:
a first planar section, said first planer section having a first exterior section, a first interior section, a first side edge and a second side edge;
a second planar section, said second planar section having a second exterior section, a second interior section, a third side edge, and a fourth side edge;
said first planar section and said second planar section being attachable along the first side edge and the third side edge, wherein said attachment provides for the first planar section to fold respectively toward the second planar section forming a receptacle therebetween;
the receptacle comprising said first interior section and said second interior section; and
a plurality of pockets of varying dimensions formed on or in said first interior section and/or said second interior section.

2. The organizer of claim 1, wherein the plurality of pockets comprise members secured to the first interior section and/or said second interior section.

3. The plurality of pockets of claim 2, wherein members are secured to the first interior section and/or said second interior section by one or more sides of the pockets.

4. The organizer of claim 1, wherein said first planar section and said second planar section are integrally attached.

5. The organizer of claim 1, wherein said first planar section and said second planar section are detachably attached.

6. The organizer of claim 1, wherein said first planar section and said second planar section are fixedly attached.

7. The organizer of claim 1, further comprising a plurality of pockets of varying dimensions formed on or in said first exterior section and/or said second exterior section.

8. The organizer of claim 1, wherein the plurality of pockets comprise substantially transparent and/or translucent members.

9. The organizer of claim 1, wherein the plurality of pockets comprise substantially opaque members.

10. The organizer of claim 1, wherein tools are selected from the group consisting of writing instruments, writing utensils, paper currency, coins, paper, order slips, lighters, bottle openers, writing tablets, PDA's, wine keys, and combinations thereof.

11. The organizer of claim 1, further comprising a third planar section.

12. The third planar section of claim 11, wherein said third planar section is attached to the first exterior section.

13. The third planar section of claim 11, wherein said third planar section is attached to the second exterior section.

14. The third planar section of claim 11, wherein said third planar section comprises letters and/or designs printed or otherwise affixed thereto.

15. The organizer of claim 11, further comprising a fourth planar section, wherein said third planar section is attached to either said first exterior section or said second exterior section and said and fourth planar section is attached to the other said first or second exterior section.

16. An organizer for holding various tools comprising:
a cover having a first side and a second side; each of said first side and said second side having an exterior surface and an interior surface, wherein the exterior surfaces folds over the interior surfaces to secure the interior surface; and
a plurality of pockets of varying dimensions residing throughout the interior surface of the cover for holding various tools.

17. The organizer of claim 16, further comprising a plurality of pockets of varying dimensions formed on or in said exterior surface of said first side and/or second side.

18. The organizer of claim 16, further comprising said first side having at least one edge and said second side having at least one edge, wherein said first side and said second side are integrally attached adjacent to said respective edges.

19. The organizer of claim 16, further comprising said first side having at least one edge and said second side having at least one edge, wherein said first side and said second side are detachably attached adjacent to said respective edges.

20. A method of utilizing an organizer for holding various wait staff tools to provide wait staff service comprising the steps of:
providing a first planar section, said first planer section having a first exterior section, a first interior section, a first side edge and a second side edge;
providing a second planar section, said second planar section having a second exterior section, a second interior section, a third side edge, and a fourth side edge;
attaching said first planar section and said second planar section along the first side edge and the third side edge
folding the first planar section toward the second planar section, wherein said folding forms a receptacle therebetween, and where said receptacle comprises said first interior section and said second interior section;
providing a plurality of pockets of varying dimensions formed on or in said first interior section and/or said second interior section;
placing wait staff tools in said plurality of pockets;
retaining said plurality of tools within said pockets and/or within said organizer; and
storing said organizer on said wait staffs person while serving patrons.
